(19) United States
(12) Patent Application Publication
(10) Pub. No.: US 2018/0108908 A1
(43) Pub. Date: Apr. 19, 2018

(54) UNIFORM STABILIZATION NANOCOATINGS FOR LITHIUM RICH COMPLEX METAL OXIDES AND ATOMIC LAYER DEPOSITION FOR FORMING THE COATING

(71) Applicant: Zenlabs Energy, Inc., Fremont, CA (US)

(72) Inventors: Bing Li, Union City, CA (US); Shabab Amiruddin, Menlo Park, CA (US); Swapnil Dalavi, Newark, CA (US)

(21) Appl. No.: 15/841,637

(22) Filed: Dec. 14, 2017

Related U.S. Application Data
(63) Continuation of application No. 13/859,070, filed on Apr. 9, 2013.

(51) Int. Cl. H01M 4/505; H01M 10/0525; H01M 4/62; H01M 4/525

(52) U.S. Cl. CPC H01M 4/505; Y02T 10/7011; H01M 10/0525; H01M 4/366; H01M 4/525; H01M 4/62

(57) ABSTRACT

Stabilization coating that are uniform and penetrating have been found to provide desirable stabilization coatings for lithium rich metal oxide cathode active materials. In particular, the uniform and penetrating coatings can be particularly desirable for improving storage stability of batteries formed with the active material. The stabilization coatings can be inert metal oxides, such as aluminum oxide. The uniform and penetrating stabilization coatings can be formed using atomic layer deposition. The coatings can further effectively stabilize cycling of the batteries, and batteries formed with the stabilization coating can exhibit modest increases in DC electrical resistance.

### CROSS REFERENCE TO RELATED APPLICATIONS

This application is a continuation of U.S. patent application Ser. No. 13/859,070 filed on Apr. 9, 2013 to Li et al., entitled “Uniform Stabilization Nanocoatings for Lithium Rich Complex Metal Oxides and Atomic Layer Deposition for Forming the Coatings,” incorporated herein by reference.

### FIELD OF THE INVENTION

The inventions, in general, are related to highly uniform surface coatings on high capacity lithium metal oxide material to stabilize the materials during electrochemical cycling.

### BACKGROUND OF THE INVENTION

Rechargeable lithium ion batteries, also known as secondary lithium ion batteries are desirable as power sources for a wide range of applications. Their desirability stems from their relative high energy density. For some current commercial batteries, the negative electrode material can be graphite, and the positive electrode material can comprise, for example, lithium cobalt oxide (LiCoO₂), LiMn₂O₄, having a spinel structure, or LiFePO₄, having an olivine structure.

The capacities of secondary lithium ion batteries have been greatly improved with the development of high capacity lithium rich metal oxides for use as positive electrode active materials. For some important applications, such as vehicle application, it is desired that secondary lithium ion batteries be able to charge and recharge for many cycles without a great loss of performance. Lithium ion batteries generally can be designed in particular for high energy power output with high current capabilities or high power output with moderate current capabilities. With either type of design, it is desirable for the average voltage and capacity to fade slowly with cycling such that power and energy output correspondingly changes slowly with cycling.

### SUMMARY OF THE INVENTION

In a first aspect, the invention pertains to a battery comprising a positive electrode comprising a cathode active material and a negative electrode comprising graphitic carbon. The cathode active material can comprise a lithium rich metal oxide approximately represented by the formula Li_{1+c}M_{1-d}₂, where c≥0, d is from about c−0.2 to about c+0.2 with the proviso that d≥0 and a uniform and up to about 5 mole percent of the oxygen can be replaced with a fluorine dopant and a penetrating stabilization coating having an average thickness of no more than about 5 nm. In some embodiments, the battery maintains at least about 85% capacity following 12 weeks of storage at 45° C. at 4.35V.

In further aspects, the invention pertains to an electrode for a lithium ion battery comprising a cathode active composition that comprises a lithium rich metal oxide and a uniform and penetrating coating with an average thickness of no more than about 5 nm. In some embodiments the lithium rich metal oxide is approximately represented by a formula L_{1+b}Ni_{α}Mn_{β}Co_{γ}A_{δ}O₂, where b ranges from about 0.05 to about 0.3, α ranges from 0 to about 0.4, β range from about 0.2 to about 0.65, γ ranges from 0 to about 0.46, and δ ranges from 0 to about 0.15 with the proviso that both α and γ are not zero, and where A is Mg, Sr, Ba, Cd, Zn, Al, Ga, B, Zr, Ti, Ca, Ce, Y, Nb, Cr, Fe, V, or combinations thereof. The electrode can exhibit manganese deposition into a carbon based counter electrode of a corresponding battery of no more than about 140 ppm as measured following discharge to 2V after a week of storage at 4.35V at 60° C. and disassembly of the battery to obtain the counter electrode.

In additional aspects, the invention pertains to a battery comprising a positive electrode comprising a cathode active material and a negative electrode comprising graphitic carbon. In general, the cathode active material can comprise a lithium rich metal oxide and a uniform and penetrating coating with an average thickness of no more than about 5 nm. In some embodiments, the lithium rich metal oxide is approximately represented by a formula L_{1+b}Ni_{α}Mn_{β}Co_{γ}A_{δ}O₂, where b ranges from about 0.05 to about 0.3, α ranges from 0 to about 0.4, β range from about 0.2 to about 0.65, γ ranges from 0 to about 0.46, and δ ranges from 0 to about 0.15 with the proviso that both α and γ are not zero, and where A is Mg, Sr, Ba, Cd, Zn, Al, Ga, B, Zr, Ti, Ca, Ce, Y, Nb, Cr, Fe, V, or combinations thereof. The battery can have a capacity at the 1000th cycle that is at least about 75% of the 5th cycle capacity cycling at 1C discharge rate at 45° C. between 4.35V and 2.2V.

Moreover, the invention pertains to a battery electrode comprising a lithium rich metal oxide approximately represented by the formula L_{1+c}M_{1-d}O₂, where c≥0, d is from about c−0.2 to about c+0.2 with the proviso that d≥0 and a uniform and up to about 5 mole percent of the oxygen can be replaced with a fluorine dopant, a penetrating stabilization coating having an average thickness of no more than about 5 nm and a metal halide overcoat.

### BRIEF DESCRIPTION OF THE DRAWINGS

FIG. 1A is an expanded view of a pouch battery with a battery core separated from two portions of the pouch case.

FIG. 1B is a perspective lower face view of the assembled pouch battery of FIG. 1A.

FIG. 1C is a bottom plan view of the pouch battery of FIG. 1B.

FIG. 1D is depiction of an embodiment of a battery core comprising an electrode stack.

FIG. 2 is a micrograph taken by focused ion beam-transmission electron microscopy of a cross section of an electrode following 8 atomic layer deposition (ALD) of Al₂O₃ coating material.

FIG. 3A is a micrograph corresponding to region b of the micrograph displayed in FIG. 2, taken at higher resolution.

FIG. 3B is a micrograph corresponding to region f of the micrograph displayed in FIG. 2, taken at higher resolution.

FIG. 3C is a micrograph corresponding to region d of the micrograph displayed in FIG. 2, taken at higher resolution.

FIG. 3D is a micrograph corresponding to region e of the micrograph displayed in FIG. 2, taken at higher resolution.

FIG. 3E is a micrograph corresponding to region g of the micrograph displayed in FIG. 2, taken at higher resolution.

FIG. 4 is a plot of relative capacity as a function of storage time for batteries formed with cathodes having no coating, 2 layer ALD coating, 5 layer ALD coating and 8 layer ALD coating following storage at 4.35V at 45° C. for up to 12 weeks after an initial charge to 4.5V.

FIG. 5 is a plot of relative capacity as a function of storage time for batteries formed with cathodes having no coating and 5 layer ALD coating following storage at 4.35V at 45° C. for up to 12 weeks after an initial charge to 4.35V.

FIG. 6 is a plot of DC resistance as a function of state of charge for batteries formed with cathodes having no coating, 2 layer ALD coating, 5 layer ALD coating and 8 layer ALD coating in which state of charge is evaluated relative to a voltage range from 4.35V to 2V after an initial activation charge of 4.6V.

FIG. 7 is a plot of DC resistance as a function of state of charge for batteries formed with cathodes having no coating and 5 layer ALD coating in which state of charge is evaluated relative to a voltage range from 4.35V to 2V after an initial activation charge of 4.35V.

FIG. 8 is a plot of DC resistance as a function of state of charge for batteries formed with cathodes having no coating and AlF₃ coatings in which state of charge is evaluated relative to a voltage range from 4.35V to 2V after an initial activation charged of 4.6V.

FIG. 9 is a plot of relative capacity as a function of cycle for up to 1000 cycles from 4.35V to 2.2V at a discharge rate of 1 C at a temperature of 45° C. for batteries formed with cathodes having no coating, 2 layer ALD coating, 5 layer ALD coating and 8 layer ALD coating and activated at 4.6V at a rate of C/10.

FIG. 10 is a plot of relative capacity as a function of cycle for up to 1000 cycles from 4.35V to 2.2V at a discharge rate of 1C at a temperature of 45° C. for batteries formed with cathodes having no coating and 5 layer ALD coating and activated at 4.35V at a rate of C/10.

FIG. 11 is a plot of specific capacity as a function of cycle for up to 1000 cycles from 4.35V to 2.2V at a discharge rate of 1C at a temperature of 45° C. after an initial charge to 4.6V at C/10 for batteries formed with cathodes having no coating, 2 layer ALD coating, 5 layer ALD coating and 8 layer ALD coating and activated at 4.6V, which correspond to un-normalized versions of the plots in FIG. 9.

FIG. 12 is a plot of specific capacity as a function of cycle for up to 1000 cycles from 4.35V to 2.2V at a discharge rate of 1C at a temperature of 45° C. after an initial charge to 4.35V at C/10 for batteries formed with cathodes having no coating or a 5 layer ALD coating and activated at 4.35V, which correspond to un-normalized version of the plots in FIG. 10.

### DETAILED DESCRIPTION

A uniform stabilization coating over a lithium rich complex metal oxide can significant stabilize the material. The stabilization is reflected in reduced dissolution of transition metals from the active materials into the electrolyte. However, the coatings can inhibit the ease of incorporation and release of lithium from the active material. To reduce the inhibition of the lithium flow, the coating layer can be made thinner. The engineering of the coating can be designed to balance various factors. Based on the ability to form a more uniform coating, the shelf life of corresponding batteries can be significantly improved. Atomic layer deposition provides an approach for the formation of a very uniform and very thin nanocoating. In atomic layer deposition, the coating is deposited in a gas phase reaction, and with sequential half reactions the amount of deposited coating can be controlled. Through the use of a gas phase reaction, the coating can be very penetrating and uniform with porous and/or irregular active materials. Through the use of more uniform penetrating coatings, important shelf life stability can be introduced that provides significant commercial advantages.

Lithium rich complex metal oxides have been found to provide a high specific capacity that can be cycled out to thousands of cycles with good power generation. Stabilization coatings have been found to impart important functionality with respect to obtaining these outstanding high capacity cycling. The materials have been found to have good specific capacity at high discharge rates with appropriate coatings. With the more uniform and penetrating coatings, transition metal dissolution is significant reduced during the first cycle activation, especially at higher voltages and the shelf life is found to significantly stabilize. While not wanting to be limited by theory, the results herein suggest that prior stabilization coatings, while relatively uniform, may have nanoscale gaps that can lead to instabilities but may correspondingly facilitate lithium release and uptake from the coated material. The more uniform penetrating coatings seem particularly sensitive to thickness with respect to discharge rate capability of the material. However, the increased stability may provide for stabile cycling to large numbers of cycles at higher charge voltages. Also, the increased stability can be particularly desirable to improve shelf life of the batteries.

The batteries described herein are lithium-based batteries in which a non-aqueous electrolyte solution comprises lithium ions. For secondary lithium ion batteries during charge, oxidation takes place at the cathode (positive electrode) where lithium ions are extracted and electrons are released. During discharge, reduction takes place in the cathode where lithium ions are inserted and electrons are consumed. Generally, the batteries are formed with lithium ions in the positive electrode material such that an initial charge of the battery transfers a significant fraction of the lithium from the positive electrode material to the negative electrode material to prepare the battery for discharge. Unless indicated otherwise, performance values referenced herein are at room temperature, i.e., from 22° C. to 25° C.

The word “element” is used herein in its conventional way as referring to a member of the periodic table in which the element has the appropriate oxidation state if the element is in a composition and in which the element is in its elemental form, M⁰, only when stated to be in an elemental form. Therefore, a metal element generally is only in a metallic state in its elemental form or a corresponding alloy of the metal's elemental form. In other words, a metal oxide or other metal composition, other than metal alloys, generally is not metallic. The term “pristine” is used herein interchangeably with the term “uncoated” to refer to a positive electrode active composition that is not coated with a stabilization coating.

Lithium ion batteries described herein have achieved excellent performance associated with the stabilization coatings while exhibiting good specific capacity and high average voltage as well as improved shelf life. The improved cycling performance suggests that the resulting lithium ion batteries can serve as an improved power source, particularly for high energy applications, such as electric vehicles, plug in hybrid vehicles and the like. In general, the stabilization coating described herein can provide desirable improvements in battery performance for a wide range of positive electrode active materials. In some embodiments, the structure of the cathode composition can be, for example, layered-layered materials, and. layered-spinel materials.

In some embodiments, the lithium ion batteries can use a positive electrode active material that is lithium rich relative to a reference homogenous electroactive lithium metal oxide composition. The excess lithium can be referenced relative to a composition LiMO₂, where M is one or more metals with an average oxidation state of +3. The additional lithium in the initial cathode material can provide corresponding greater amounts of cycling lithium that can be transferred to the negative electrode during charging to increase the battery capacity for a given weight of cathode active material. In some embodiments, the additional lithium is accessed at higher voltages such that the initial charge takes place at a higher voltage to access the additional capacity represented by the additional lithium of the positive electrode.

Lithium rich positive electrode active compositions of particular interest can be approximately represented in a single component notation with a formula L_{1+b}Ni_{α}Mn_{β}Co_{γ}A_{δ}O_{2-z}F_{z}, where b ranges from about 0.05 to about 0.3, α ranges from about 0.1 to about 0.4, β ranges from about 0.2 to about 0.65, γ ranges from about 0 to about 0.46, δ ranges from about 0 to about 0.15, and z ranges from 0 to about 0.2, and where A is Mg, Sr, Ba, Cd, Zn, Al, Ga, B, Zr, Ti, Ca, Ce, Y, Nb, Cr, Fe, V, Li or combinations thereof. Furthermore, emerging cathode active compositions of potential commercial significance are lithium rich as well as a layered-layered multiphase structure in a highly crystalline composition, in which the additional lithium supports the formation of an alternative crystalline phase.

In particular, it is believed that appropriately formed lithium-rich lithium metal oxides have a composite crystal structure in which the excess lithium supports the formation of an alternative crystalline phase, which leads to the multiphased structure. For example, in some embodiments of lithium rich materials, a layered Li₂MnO₃ material may be structurally integrated with either a layered LiMO₂ component or similar composite compositions with the manganese cations substituted with other transition metal cations with appropriate oxidation states. In some embodiments, the positive electrode material can be represented in two component notation as x Li₂M′O₃.(1−x)LiMO₂ where M is one or more metal cations with an average valance of +3 with at least one cation being a Mn ion or a Ni ion such as a combination of Mn, Co, and Ni, and where M′ is one or more metal cations with an average valance of +4. These compositions are described further, for example, in published U.S. Patent Application 2011/0052981 to Lopez et al. (the '981 application), entitled “Layer-layer Lithium Rich Complex Metal Oxides with High Specific Capacity and Excellent Cycling,” incorporated herein by reference.

It has been observed that the layered-layered lithium rich active materials exhibit a complex electrochemical behavior. For example, the mixed phase lithium rich metal oxide materials can undergo significant irreversible changes during the first charge of the battery, but these lithium rich compositions can still exhibit surprisingly large specific discharge capacity on cycling. Desirable coatings can reduce the first cycle irreversible capacity loss. Also, the cycling can be stabilized, such as with the coatings described herein, such that the high specific capacity can be exploited for a significant number of cycles. Furthermore, layered-spinel materials have been discovered that also exhibit a complex electrochemical behavior. The layered-spinel materials are described in copending U.S. patent application Ser. Nos. 13/710,713, now published application 2013/0149609, to Deng et al., entitled “Lithium Metal Oxides With Multiple Phases and Stable High Energy Electrochemical Cycling,” and 13/747,735, now U.S. Pat. No. 9,070,489, to Sharma et al., entitled “Mixed Phase Lithium Metal Oxide Compositions With Desirable Battery Performance,” both of which are incorporated herein by reference.

Specific ranges of lithium rich metal oxide compositions have been identified that provide an improved balance between particular performance properties, such as a high specific capacity, performance at higher rates, desired values of DC-resistance, average voltage and cycling properties when incorporated into a lithium based battery in the '981 application cited above and U.S. patent application Ser. No. 13/588,783, now U.S. Pat. No. 9,552,901, to Amiruddin et al. entitled “Lithium Ion Batteries with High Energy Density, Excellent Cycling Capability and Low Internal Impedance”, incorporated herein by reference. The stabilization coatings described herein can further improve the performance of these positive electrode active compositions.

When the corresponding batteries with the intercalation-based positive electrode active materials are in use, the intercalation and release of lithium ions from the lattice induces changes in the crystalline lattice of the electroactive material. As long as these changes are essentially reversible, the capacity of the material does not change significantly with cycling. However, the capacity of the active materials is observed to decrease with cycling to varying degrees. Thus, after a number of cycles, the performance of the battery falls below acceptable values, and the battery is replaced. Also, on the first cycle of the battery, generally there is an irreversible capacity loss that is significantly greater than per cycle capacity loss at subsequent cycles. The irreversible capacity loss (IRCL) is the difference between the charge capacity of the new battery and the first discharge capacity. The irreversible capacity loss results in a corresponding decrease in the capacity, energy and power for the cell. The irreversible capacity lose generally can be attributed to changes of the battery materials during the initial charge-discharge cycle that are substantially maintained during subsequent cycling of the battery. Some of the first cycle irreversible capacity losses (IRCL) can be attributed to the positive electrode active materials, and the coated materials described herein can result in a decrease in the irreversible capacity loss of the batteries.

For some of the lithium rich compositions, uncoated cathode compositions can have exceptionally high capacity when cycled to a high voltage cut-off of 4.5 or 4.6 volts. During the first activation cycle, the evolution of oxygen can be associated with a higher IRCL in these type of Li enriched cathode compositions, in which the oxygen may be generated from a reaction such as Li₂MnO₃→MnO₂+2Li⁺+2e⁻+1/2 O₂. Also, significant capacity fade can be seen occurring over extended periods of cycling especially at higher currents or discharge rates. A potential contribution to the capacity fade is a higher charge cut-off voltage, which might trigger the possible dissolution of non-lithium metal ions, especially Mn, from the positive electrode. The Mn dissolution may occur through a disproportionation reaction of Mn³⁺, specifically 2Mn³⁺→Mn²⁺+Mn⁴⁺, where the Mn²⁺ is believed to migrate to the electrolyte and to the anode, i.e., negative electrode, resulting in a capacity fade. The disproportionation reaction of Mn⁺³ may occur spontaneously with greater frequency at higher temperatures and at greater charge/ discharge rates. A desirable stabilization coating may decrease irreversible changes to the lithium metal oxide active materials that can also contribute to capacity fade with cycling as well as the first cycle irreversible capacity loss. By incorporating a highly uniform and penetrating coating on the surface of the high capacity cathode particles, the cycle life of the high capacity cathode based lithium ion cell battery can be improved. While not wanting to be limited by theory, the coatings may stabilize the crystal lattice of the positive electrode active material during the uptake and release of lithium ions so that irreversible changes in the crystal lattice are reduced significantly.

Some materials have been previously studied as stabilizing coatings for positive electrode active materials in lithium ion batteries. In particular, metal fluoride nanocoatings and other metal halide nanocoatings have been found to be effective to significantly stabilize and improve the performance of high capacity lithium rich metal oxides. Furthermore, inert metal oxide coatings have been deposited as stabilizing nanocoatings. Improved solution deposited stabilizing nanocoatings, such as metal fluoride nanocoatings, with appropriately engineered thicknesses are described in published U.S. Patent Application 2011/0111298 to Lopez et al, (the '298 application) entitled “Coated Positive Electrode Materials for Lithium Ion Batteries,” incorporated herein by reference. Non-fluoride, metal halide (chloride, bromide, and iodide) coatings have been found to provide significant stabilization for lithium rich positive electrode active materials for lithium ion batteries as disclosed in published U.S. patent application Ser. No. 2012/0070725 to Venkatachalam et al., entitled “Metal Halide Coatings on Lithium Ion Battery Positive Electrode Materials and Corresponding Batteries”, incorporated herein by reference (hereinafter the '725 application). Various other coatings such as Al₂O₃, AlPO₄, ZrO₂, and Bi₂O₃, etc. to improve the material properties which in turn improves the electrochemical performance have been reported for layered-layered lithium rich metal oxides. See, for example, published U.S. Patent Application 2011/0076556 to Karthikeyan et al. (the '556 application), entitled “Metal Oxide Coated Positive Electrode Materials for Lithium-Based Batteries”, incorporated herein by reference. Metal oxide coatings were effective to improve performance properties for lithium rich metal oxide positive electrode active materials.

Recently, it has been discovered that inert mixed metal oxide coatings can be particularly effective to stabilize the active positive electrode materials. Also, it has been found that a metal halide coating over a metal oxide coating can provide synergistic improvement in the stabilization of the active material. Aluminum zinc oxide coatings and combined metal oxide and metal halide coatings are described in detail in copending U.S. patent application Ser. No. 13/722,597, now published U.S. patent application 2014/0178760, (the '597 application) to Bowling et al., entitled “High Capacity Cathode Material With Stabilizing Nanocoatings,” incorporated herein by reference.

Solution based nanocoating processes have been effective to provide excellent long term cycling performance along with other stabilization efforts, such as appropriate electrolyte selection, voltage window selection and battery design. It has been possible to obtain good cycling at relatively high discharge rates. Stable cycling over a reduced voltage window out to several thousand cycles is described further in published U.S. Patent Application 2012/0056590 to Amiruddin et al. (“the '590 application”), entitled “Very Long Cycling of Lithium Ion Batteries With Lithium Rich Cathode Materials,” incorporated herein by reference.

In general, a thicker stabilization coating can be expected to provide more stabilization of the material. Thus, the irreversible capacity loss can be observed to decrease with increasing coating thickness. However, additional inert coating provides added weight to the active material. Also, more importantly the electrochemical performance of the active material with respect to capacity, especially with increasing discharge rate, can deteriorate with increasing stabilization coating thickness, and the average voltage may also decrease. The balance of performance and stability have been examined in detail as described in the '298 application.

Atomic layer deposition developed to provide thin films with atomic layer control. Atomic layer deposition (ALD) uses gas phase species that are used to perform specific surface reactions. Two sequential reactants are used to provide control through self limitation of the reaction at each step. It has been asserted that ALD can be used to form conformal coatings for porous materials, see Elam et al., “Viscous flow reactor with quartz crystal microbalance for thin film growth by atomic layer deposition,” Review of Scientific Instruments, Vol. 73(8), 2981-2987 (Aug. 2002), incorporated herein by reference. Aluminum oxide has been deposited on commercial LiCoO2 materials for battery electrodes using ALD, and the coating can be applied to a powder of the active material or directly to the battery electrode. See, for example, Jung et al., “Ultrathin Direct Atomic Layer Deposition on Composite Electrodes for Highly Durable and Safe Li-Ion Batteries,” Advanced Materials, Vol. 22, 2172-2176 (April 2010), Jung et al., “Enhanced Stability of LiCoO₂ Cathodes in Lithium-Ion Batteries Using Surface Modification by Atomic Layer Deposition,” Journal of the Electrochemical Society, Vol. 157(1) A75-A81 (November 2009), and published U.S. Patent Application 2012/0077082 to Se-Hee et al. (“the '082 application”), entitled “Lithium Battery Electrodes With Ultra-Thin Alumina Coatings,” all three of which are incorporated herein by reference.

It has been surprisingly discovered that improved uniformity and/or penetrating deposition of the stabilization coating provides for significant improvement of the stabilization of lithium rich complex metal oxides. The solution deposited metal halide and metal oxide stabilization coatings appear relatively uniform over the particle surfaces and have a nanoscale thickness as evaluated by microscopy. In the examples, results are presented using atomic layer deposition demonstrate a surprising improvement in material stability relative to solution deposited uniform nanocoatings. The stabilization can be evaluated through measurements of manganese dissolution into the electrolyte and shelf life. But it has also been surprisingly found that thin coatings deposited by atomic layer deposition affect electrochemical performance greater than expected based on the thickness of the coatings. Thus, with lithium rich metal oxide active materials, the balance of factors in engineering the coating properties can be more pronounced for atomic layer deposition coatings. Based on the results herein, improved penetrating coatings are being explored using solution deposition approaches.

The previous solution based deposition results referenced above suggest that a uniform coating on the complex lithium metal oxides should not be too thin or too thick. The result with highly uniform and penetrating coatings suggests similar trends, but at a smaller average thickness and with additional factors for consideration. If the highly uniform and penetrating coatings become too thick the impedance increases, which is reflected in the specific capacity and DC resistance measurements. If the highly uniform and penetrating coatings are too thin, the desired degree of stabilization is not achieved.

In comparing earlier aluminum oxide coatings formed with solution deposition with coatings described here several factors point to distinctions in the coatings. The batteries with the highly uniform and penetrating coatings seem to have increased stability as measured by manganese dissolution as well as the initial calendar life evaluations. On the other hand, solution deposited metal oxide coatings can actually result in an increase in specific capacity for thinner coatings relative to the specific capacity of the uncoated materials. The highly uniform and penetrating coatings seem to decrease the specific capacity even at the small thicknesses achievable. These distinctions suggest significant differences in the nature of the coatings. The solution based coatings generally appear relatively uniform in micrographs, which suggests perhaps a significant distinction in penetration into the porous active material, although Applicant does not want to be limited by theory. The physical measurements of performance provide the clearest evidence of the distinctions in the coatings with additional work underway to further understand the coating materials.

In summary, the uniform and penetrating coatings are especially effective to stabilize lithium rich metal oxide materials. The improved stability can be found to significantly reduce manganese dissolution from the active material upon initial activation during the first charge step. The improved stability is particularly effective to improve shelf life, which is a significant commercial parameter for a battery. The penetrating coatings can be designed such that the resistance of the material does not increase too much. Also, the penetrating coatings can be designed to significantly stabilize cycling of the battery.

### Positive Electrode Active Material

Generally, a lithium rich metal oxide composition can be represented approximately with a formula Li_{1+c}M_{1-d}O₂, where M represents one or more non-lithium metals, c>0, and d is related to c based on the average valence of the metals. When c is greater than 0, the composition is lithium rich relative to the reference LiMO₂ composition. Optionally, a portion of the oxygen can be replaced with a fluorine dopant, such as up to 10 mole percent. The positive electrode active materials of particular interest comprise lithium rich compositions that generally are believed to form a layered-layered composite crystal structure. In the layered-layered composite compositions, c can be approximately equal to d. In some embodiments, c is from about 0.01 to about 0.33, and d is from about c−0.2 to about c+0.2 with the proviso that d>0. For these layered layered compositions, it is generally desirable for M to include manganese, in some embodiments at least about 25 mole percent manganese. The additional lithium in the initial cathode material can provide to some degree corresponding additional active lithium for cycling that can increase the battery capacity for a given weight of cathode active material.

In some embodiments, the lithium metal oxide compositions specifically comprise Ni, Co and Mn ions with an optional metal dopant. In general, the additional lithium in the lithium rich compositions is accessed at higher voltages such that the initial charge takes place at a relatively higher voltage to access the additional capacity. However, as described herein the material can undergo irreversible changes during an initial high voltage charge step, such that the material that cycles subsequent to the initial charge is not the same material that reacts at high voltage in the initial material. As used herein, the notation (value 1≤variable≤value2) implicitly assumes that value 1 and value 2 are approximate quantities.

Lithium rich positive electrode active materials of particular interest can be represented approximately by a formula L_{1+b}Ni_{α}Mn_{β}Co_{γ}A_{δ}O_{2-z}F_{z}, where b relates to the degree of lithium enrichment, α ranges from about 0 to about 0.4, β range from about 0.2 to about 0.65, γ ranges from 0 to about 0.46, δ ranges from 0 to about 0.15 and z ranges from 0 to about 0.2 with the proviso that both a and y are not zero, and where A is a metal different from Mn, Ni, or Co, such as Mg, Sr, Ba, Cd, Zn, Al, Ga, B, Zr, Ti, Ca, Ce, Y, Nb, Cr, Fe, V, Li or combinations thereof. In some embodiments, b ranges from about 0.01 to about 0.3. Some particularly desirable ranges for the transition metals are also described further below. A person of ordinary skill in the art will recognize that additional ranges of parameter values within the explicit compositional ranges above are contemplated and are within the present disclosure. To simplify the following discussion in this section, the optional fluorine dopant is not discussed further, although the option of a fluorine dopant should still be considered for the particular embodiments. Desirable lithium rich compositions with a fluorine dopant are described further in published U.S. Patent Application 2010/0086854A to Kumar et al., entitled “Fluorine Doped Lithium Rich Metal Oxide Positive Electrode Battery Materials With High Specific Capacity and Corresponding Batteries,” incorporated herein by reference. Compositions in which A is lithium as a dopant for substitution for Mn are described in published U.S. Patent Application 2011/0052989A to Venkatachalam et al., entitled “Lithium Doped Cathode Material,” incorporated herein by reference. The specific performance properties obtained with +2 metal cation dopants, such as Mg⁺², are described in published U.S. Patent Application 2011/0244331 to Karthikeyan et al., entitled “Doped Positive Electrode Active Materials and Lithium Ion Secondary Batteries Constructed Therefrom,” incorporated herein by reference.

If b+α+β+γ+δ is approximately equal to 1, the positive electrode material with the formula above can be represented approximately in two component notation as x Li₂M′O₃. (1−x)LiMO₂ where 0<x<1, M is one or more metal cations with an average valence of +3 within some embodiments at least one cation being a Mn ion or a Ni ion and where M′ is one or more metal cations, such as Mn⁺⁴, with an average valence of +4. As noted above, it is believed that the corresponding material has two distinct physical phases related to the separate components of the two component notation. The multi-phased material is believed to have an integrated layered-layered composite crystal structure with the excess lithium supporting the stability of the composite material. For example, in some embodiments of lithium rich materials, a layered Li₂MnO₃ material may be structurally integrated with a layered LiMO₂ component where M represents selected non-lithium metal elements or combinations thereof.

Recently, it has been found that the performance properties of the positive electrode active materials can be engineered around the specific design of the composition stoichiometry. The positive electrode active materials of particular interest can be represented approximately in two component notation as x Li₂MnO₃.(1−x) LiMO₂, where M is one or more metal elements with an average valence of +3 and with one of the metal elements being Mn and with another metal element being Ni and/or Co. For example, M can be a combination of nickel, cobalt and manganese, which, for example, can be in oxidation states Ni⁺², Co⁺³, and Mn⁺⁴ within the initial lithium manganese oxides. The overall formula for these compositions can be written as Li_{2(1+x)/(2+x)}Mn_{2x/(2+x)}M_{(2-2x)/(2+x)}O₂. In the overall formula, the total amount of manganese has contributions from both constituents listed in the two component notation. Thus, in some sense the compositions are manganese rich. The value of x, as with the value of parameter “b” above, relates to the lithium enrichment. In general, 0<x<1, but in some embodiments 0.03≤x≤0.55, and in further embodiments 0.05≤x≤0.425. Some particular ranges of x or b to provide specific desired properties are described further in the '981 application. A person of ordinary skill in the art will recognize that additional ranges within the explicit ranges of parameter x above are contemplated and are within the present disclosure.

In some embodiments, M as represented in the two component notation above can be written as NiᵤMnᵥCo_{w}A_{y}. For embodiments in which y=0, this simplifies to NiᵤMnᵥCo_{w}. If M includes Ni, Co, Mn, and optionally A the composition can be written alternatively in two component notation and single component notation as the following:

x Li₂MnO₃.(1−x)Li NiᵤMnᵥCo_{w}A_{y}O₂, (1)

L_{1+b}Ni_{α}Mn_{β}Co_{γ}A_{δ}O₂, (2)

with u+v+w+y≈1 and b+α+β+γ+δ≈1. The reconciliation of these two formulas leads to the following relationships:

b=x/(2+x),

α=2 u(1−x)/(2+x),

β=2 x/(2+x)+2 v(1−x)/(2+x),

γ=2 w(1−x)/(2+x),

δ=2 y(1−x)/(2+x),

and similarly,

x=2b/(1−b),

u=α/(1−3b),

v=(β−2b)/(1−3b),

w=γ/(1−3b),

y=δ/(1−3b).

In some embodiments, b ranges from about 0.05 to about 0.3, a ranges from 0 to about 0.4, β range from about 0.2 to about 0.65, γ ranges from 0 to about 0.46, and δ ranges from 0 to about 0.15 with the proviso that both a and y are not zero, and where A is Mg, Sr, Ba, Cd, Zn, Al, Ga, B, Zr, Ti, Ca, Ce, Y, Nb, Cr, Fe, V, or combinations thereof. It may be desirable in some embodiments to have u≈v, such that Li NiᵤMnᵥCo_{w}A_{y}O₂ becomes approximately Li NiᵤMnᵤCo_{w}A_{y}O₂. In this composition, when y=0, the average valence of Ni, Co and Mn is +3, and if u≈v, then these elements can have valences of approximately Ni⁺², Co⁺³ and Mn⁺⁴ to achieve the average valence. When the lithium is hypothetically fully extracted, all of the elements go to a +4 valence. A balance of Ni and Mn can provide for Mn to remain in a +4 valence as the material is cycled in the battery. This balance may avoid or limit the formation of Mn⁺³, which has been associated with dissolution of Mn into the electrolyte and a corresponding loss of capacity. Also, some variation of compositions around the compositions with u≈v, e.g., u=v+Δ, can provide alternative useful composition embodiments as described in the '981 application.

In some embodiments, the Ni, Mn, Co and A values in the composition formula (2) above can be specified as 0.225≤α≤0.35, 0.3≤β≤0.55, 0.15≤γ≤0.3, 0≤δ<0.05, in further embodiments as 0.23≤α≤0.34, 0.325≤β≤0.525, 0.15≤γ≤0.29, 0≤δ≤0.04, and in other embodiments as 0.24≤α≤0.33, 0.35≤β<0.5, 0.15≤γ≤0.275, 0≤δ≤0.0375, with the proviso that b+α+β+γ+δ≈1. A person of ordinary skill in the art will recognize that additional ranges of composition parameters within the explicit ranges and independently varied between the 4 separate parameters above as well as the lithium enrichment parameter (b) in the ranges in the above paragraphs are contemplated and are within the present disclosure.

In general, various processes can be performed for synthesizing the desired lithium rich metal oxide materials described herein having nickel, cobalt, manganese and additional optional metal cations in the composition and exhibiting the high specific capacity performance. In particular, for example, sol gel, co-precipitation, solid state reactions and vapor phase flow reactions can be used to synthesize the desired materials. In addition to the high specific capacity, the materials can exhibit a good tap density which leads to high overall capacity of the material in fixed volume applications.

Specifically, the synthesis methods based on co-precipitation have been adapted for the synthesis of compositions with the formula L_{1+b}Ni_{α}Mn_{β}Co_{γ}A_{δ}O_{2-z}F_{z}, as described above. In the co-precipitation process, metal salts are dissolved into an aqueous solvent, such as purified water, with a desired molar ratio. Suitable metal salts include, for example, metal acetates, metal sulfates, metal nitrates, and combination thereof. The concentration of the solution is generally selected between 1 M and 3 M. The relative molar quantities of metal salts can be selected based on the desired formula for the product materials. Similarly, the dopant elements can be introduced along with the other metal salts at the appropriate molar quantity such that the dopant is incorporated into the precipitated material. The pH of the solution can then be adjusted, such as with the addition of Na₂CO₃ and/or ammonium hydroxide, to precipitate a metal hydroxide or carbonate with the desired amounts of metal elements. Generally, the pH can be adjusted to a value between about 6.0 to about 12.0. The solution can be heated and stirred to facilitate the precipitation of the hydroxide or carbonate. The precipitated metal hydroxide or carbonate can then be separated from the solution, washed and dried to form a powder prior to further processing. For example, drying can be performed in an oven at about 110° C. for about 4 to about 12 hours. A person of ordinary skill in the art will recognize that additional ranges of process parameters within the explicit ranges above are contemplated and are within the present disclosure.

The collected metal hydroxide or carbonate powder can then be subjected to a heat treatment to convert the hydroxide or carbonate composition to the corresponding oxide composition with the elimination of water or carbon dioxide. Generally, the heat treatment can be performed in an oven, furnace or the like. The heat treatment can be performed in an inert atmosphere or an atmosphere with oxygen present. In some embodiments, the material can be heated to a temperature of at least about 350° C. and in some embodiments from about 400° C. to about 800° C. to convert the hydroxide or carbonate to an oxide. The heat treatment generally can be performed for at least about 15 minutes, in further embodiments from about 30 minutes to 24 hours or longer, and in additional embodiments from about 45 minutes to about 15 hours. A further heat treatment can be performed at a second higher temperature to improve the crystallinity of the product material. This calcination step for forming the crystalline product generally is performed at temperatures of at least about 650° C., and in some embodiments from about 700° C. to about 1200° C., and in further embodiments from about 700° C. to about 1100° C. The calcination step to improve the structural properties of the powder generally can be performed for at least about 15 minutes, in further embodiments from about 20 minutes to about 30 hours or longer, and in other embodiments from about 1 hour to about 36 hours. The heating steps can be combined, if desired, with appropriate ramping of the temperature to yield desired materials. A person of ordinary skill in the art will recognize that additional ranges of temperatures and times within the explicit ranges above are contemplated and are within the present disclosure.

The lithium element can be incorporated into the material at one or more selected steps in the process. For example, a lithium salt can be incorporated into the solution prior to or upon performing the precipitation step through the addition of a hydrated lithium salt. In this approach, the lithium species is incorporated into the hydroxide or carbonate material in the same way as the other metals. Also, due to the properties of lithium, the lithium element can be incorporated into the material in a solid state reaction without adversely affecting the resulting properties of the product composition. Thus, for example, an appropriate amount of lithium source generally as a powder, such as LiOH.H₂O, LiOH, Li₂CO₃, or a combination thereof, can be mixed with the precipitated metal carbonate or metal hydroxide. The powder mixture is then advanced through the heating step(s) to form the oxide and then the crystalline final product material. In some embodiments, incorporation of the lithium element can be achieved by a combination of the solution approach and the solid state approach.

Further details of the hydroxide co-precipitation process are described in published U.S. Patent Application 2010/0086853A (the '853 application) to Venkatachalam et al. entitled “Positive Electrode Material for Lithium Ion Batteries Having a High Specific Discharge Capacity and Processes for the Synthesis of these Materials”, incorporated herein by reference. Further details of the carbonate co-precipitation process are described in published U.S. Patent Application 2010/0151332A (the '332 application) to Lopez et al. entitled “Positive Electrode Materials for High Discharge Capacity Lithium Ion Batteries”, both incorporated herein by reference.

Co-precipitation techniques have been found to be useful for forming active materials with a relatively high tap density and high specific capacities. In general, these materials are observed to have moderate particles sizes on the order of several microns in diameters, generally spherical shapes and porous.

### Coatings

The coatings of particular interest are penetrating, and this feature can be understood from the synthesis technique as well as the electrochemical measurements. It has been found that nanocoatings can provide desired stabilization of complex multiphased lithium metal oxides during electrochemical cycling. But thickness and nominal uniformity are observed to not be the only determinative factors for efficacy of the coatings with respect to providing a desired degree of stabilization. Another aspect of the coating properties is described herein as the penetrating nature of the coating, which is believed to influence the ability to provide stabilization desired for extension of shelf life and to reduce manganese dissolution. While not wanting to be limited by theory, penetration in the current coating context is believed related to the ability to cover contours and/or pores of the particles.

With respect to coating thickness, coatings can have an average thickness of no more than about 7 nm, in further embodiments no more than about 6 nm and in additional embodiments from about 0.6 nm to about 5 nm. In general, coating thickness can be evaluated using transmission electron microscopy (TEM). For atomic layer deposition (ALD) processing, a coating can have no more than 10 ALD layers, in further embodiments from 2 to 8 ALD layers and in further embodiments from 3 to 7 ALD layers, which can be determined from the processing. A person of ordinary skill in the art will recognize that additional ranges of coating thicknesses within the explicit ranges above are contemplated and are within the present disclosure.

Atomic layer deposition (ALD) can be considered in some sense a prototypical process to form a penetrating stabilization coating. ALD is directed to the formation of metal oxide coatings. However, based on the understanding obtained from the present work, it is anticipated that solution based approached for coating formation can be used to replicate at least some of the significant characteristics found with the appropriately engineered ALD coatings. The penetrating characteristic of coating cannot be presently directly evaluated, and the electrochemical characterization can be presently considered an appropriate way, and possibly the only current way, to interrogate this feature of the coating. The associated electrochemical behaviors associated with the uniform and penetrating stabilization coatings are discussed in detail below. Suitable uniform and penetrating coatings can comprise metal oxides [and mixed metal oxides], such as aluminum oxide, zinc oxide, titanium oxide, magnesium oxide, yttrium oxide, boron oxide, silicon oxide, or zirconium oxide. Based on the assumption that solution based techniques can be extended for the synthesis of uniform and penetrating coatings, these coatings can be similarly formed to comprise metal halides, i.e., metal fluorides, metal chlorides, metal bromides, and metal iodides, wherein the metal can be selected from a wide range of metals, such as aluminum, silver, sodium, zinc cadmium, boron, manganese, calcium, and the like.

It has recently been found that sequential application of a metal oxide stabilization nanocoating and a metal halide stabilization nanocoating can provide synergistic performance improvement from the layered coating. Corresponding layered nanocoatings can be applied in which at least one of the nanocoatings is a penetrating coating. For example, a solution deposited metal halide coating, such as AlF₃, can be placed over an ALD metal oxide coating to form a layered coating. The effectiveness of layered stabilization coatings is described further in the '597 application cited above. With respect to the halide overcoat, desirable stabilization overcoat amounts for metal halides, i.e., fluoride, chloride, bromide and/or iodide, generally are from about 0.025 to about 5 mole percent, in further embodiments from about 0.05 to about 2.5 mole percent, in other embodiments from about 0.075 to about 2 mole percent and in further embodiments from about 0.1 to about 1.5 mole percent. A person of ordinary skill in the art will recognize that additional ranges of coating amounts within the explicit ranges above are contemplated and are within the present disclosure.

A metal halide coating can be deposited using a solution based precipitation approach. A powder of the positive electrode active material, which can have a previously formed metal oxide stabilization coating, can be mixed in a suitable solvent, such as an aqueous solvent. A soluble composition of the desired metal/metalloid ion(s) can be dissolved in the solvent. Then, NH₄X, X═F, Cl, Br and/or I, can be gradually added to the dispersion/solution to precipitate the metal halide. The total amount of coating reactants can be selected to form the desired thickness of coating, and the ratio of coating reactants can be based on the stoichiometry of the coating material. The coating mixture can be heated during the coating process to reasonable temperatures, such as in the range from about 60° C. to about 100° C. for aqueous solutions from about 20 minutes to about 48 hours, to facilitate the coating process. After removing the coated electroactive material from the solution, the material can be dried and heated to temperatures generally from about 250° C. to about 600° C. for about 20 minutes to about 48 hours to complete the formation of the coated material. The heating can be performed under a nitrogen atmosphere or other substantially oxygen free atmosphere.

ALD deposition can be performed either to deposit the stabilization coating onto the particles of the active material or directly onto the electrode in which the active material is coated in the presence of the other electrode components. The ALD coating onto the electrodes is described in the Examples below. Both approaches share a common reaction approach with respect to sequential self-limiting surface reactions. Reactants are introduced as vapor or gas and may be accompanied by a carrier gas. An inert purge gas can be generally flushed through the system at the beginning of the process and between steps to facilitate removal of contaminants and/or unreacted excess reactants. Alternatively or additionally, a high vacuum can be used to remove contaminants and/or unreacted reactants. The reactions can be carried out in an appropriate chamber isolated from the ambient atmosphere.

In general, various inorganic materials can be formed using ALD including oxides, nitride and sulfides, for examples, using respectively water, ammonia or hydrogen sulfide as secondary reactants. The discussion focuses for convenience on metal oxide coatings and the other materials correspondingly follow. Aluminum oxide (Al₂O₃) is a useful coating material that can be conveniently deposited with ALD. An initial reactant can have a formula MX., where M is the metal or metalloid to be incorporated into the coating, X is a displaceable nucleophilic group and n indicates the stoichiometry of the compound. It is believed that M binds to a surface atom of the material, such as an oxygen atom, while maintaining bonding to the Xₙ₋₁ groups. When water is introduced in a second stage reaction step, water displaces HX, and effectively an M—OH group has been added to the surface that is then available to undergo another layer addition if desired. Following a further purging and/or evacuation of the reactor, the sequential steps can be repeated to form a desired number of ALD layers. The reactions may be thermally driven through heating, such as from about 50° C. to about 750° C., although some reactions may not involve heating. Deposition onto an electrode with a polymer binder can be performed from about 0° C. to about 250° C. for most polymers without destroying the polymer. Reactants for aluminum oxide deposition include, for example, trimethyl aluminum (Al(CH₃)₃), and a reactant for the deposition of zinc oxide (ZnO) include, for example, diethylzinc (Zn(CH₂CH₃)₂).

It has been found that aluminum zinc oxide coating can provide desirable stabilization of the complex lithium rich metal oxides. The aluminum zinc oxide coatings have been surprisingly found to stabilize the lithium rich active materials with respect to drop in average voltage during cycling, specific capacity with cycling as well as decreasing the first cycle irreversible capacity loss. The aluminum zinc oxide coating composition generally has an approximate formula as determined by analytical analysis, generally ICP-OES (inductively coupled plasma-optical emissions spectroscopy), of AlₓZn_{1-3x/2}O, where x is from about 0.01 to about 0.6, in further embodiments from about 0.05 to about 0.5 and in additional embodiments from about 0.1 to about 0.45. A person of ordinary skill in the art will recognize that additional ranges of stoichiometries (x) within the explicit ranges above are contemplated and are within the present disclosure.

To perform ALD deposition onto an electrode, the electrode can be placed into an appropriate chamber sealed from the ambient atmosphere. The chamber can be evacuated and/or purged with an inert gas sufficiently to remove any unwanted vapors. The reactants can then be alternatingly introduced into the chamber, heating can be provided to drive the particular surface reaction, and the chamber is again evacuated and/or purged to complete a reaction step prior to performing a next step. Similarly, a powder can be placed in a suitable container, such as a rotary furnace sealed form the ambient atmosphere, and the reactions cycles along with evacuation and/or purging can be performed with the powders. Irrespective of the material being coated, the performance of two alternating reactions forms a single ALD layer, and the process can be repeated to form 2, 3, 4, 5, 6, 7, 8, 9, 10, 11, 12 or more ALD layers, each formed by alternating two sequential self-limiting surface reactions. Following completion of the ALD coating, the powder can be formed into an electrode, or an electrode with an applied ALD coating can be directly assembled into a battery as described herein.

### Battery Structure

The lithium ion batteries generally comprise a positive electrode, a negative electrode, a separator between the negative electrode and the positive electrode and an electrolyte comprising lithium ions. The electrodes are generally associated with metal current collectors, such as metal foils. Lithium ion batteries refer to batteries in which the negative electrode active material is a material that takes up lithium during charging and releases lithium during discharging. A battery can comprise multiple positive electrodes and/or multiple negative electrodes, such as in a stack, with appropriately placed separators. An example of a representative pouch battery is described further below. Electrolyte in contact with the electrodes provides ionic conductivity through the separator between electrodes of opposite polarity.

Lithium has been used in both primary and secondary batteries. An attractive feature of lithium metal is its light weight and the fact that it is the most electropositive metal, and aspects of these features can be advantageously captured in lithium ion batteries also. Certain forms of metals, metal oxides, and carbon materials are known to incorporate lithium ions into the structure through intercalation, alloying or similar mechanisms. Desirable mixed metal oxides are described further herein to function as electroactive materials for positive electrodes in secondary lithium ion batteries. Lithium ion batteries refer to batteries in which the negative electrode active material is a material that takes up lithium during charging and releases lithium during discharging. If lithium metal itself is used as the anode, the resulting battery generally is referred to as a lithium battery.

The nature of the negative electrode intercalation material influences the resulting voltage of the battery since the voltage is the difference between the half cell potentials at the cathode and anode. Suitable negative electrode lithium intercalation compositions can include, for example, graphite, synthetic graphite, coke, fullerenes, other graphitic carbons, niobium pentoxide, tin alloys, silicon, titanium oxide, tin oxide, and lithium titanium oxide, such as LiₓTiO₂, 0.5<x≤1 or Li₁₊ₓTi₂₋ₓO₄, 0≤x≤1/3. In general, the primary electroactive composition used in the negative electrode can be used to describe the negative electrode. The term “carbon based negative electrode” is used to refer to an electrode that has an active material comprising predominantly an elemental carbon material, such as graphite, synthetic graphite, coke, fullerenes, other graphitic carbons, hard carbon, or a combination thereof as the primary electroactive composition. Graphite, synthetic graphite and other graphitic carbons can be collectively referred to as graphitic carbons. Carbon based materials can be desirable for use in certain battery applications since some of these materials are presently believed to be the only reliable negative electrode active material that can operate at relatively high voltages with cycling out to 1000 cycles or more.

Additional negative electrode materials are described in U.S. Pat. No. 8,277,974 to Kumar et al., entitled “High Energy Lithium Ion Batteries with Particular Negative Electrode Compositions,” and 2010/0119942 to Kumar et al., entitled “Composite Compositions, Negative Electrodes with Composite Compositions and Corresponding Batteries,” both of which are incorporated herein by reference. Desirable elemental silicon based negative electrode active materials are described in published U.S. Patent Application 2011/0111294 filed on Nov. 3, 2010 to Lopez et al., entitled “High Capacity Anode Materials for Lithium Ion Batteries,” incorporated herein by reference. Desirable silicon oxide based negative electrode active materials are described in published U.S. Patent Application 2012/0295155 filed on May 16, 2011 to Deng et al., entitled “Silicon Oxide Based High Capacity Anode Materials for Lithium Ion Batteries,” incorporated herein by reference.

The positive electrode active compositions and negative electrode active compositions generally are powder compositions that are held together in the corresponding electrode with a polymer binder. The binder provides ionic conductivity to the active particles when in contact with the electrolyte. Suitable polymer binders include, for example, polyvinylidine fluoride, polyethylene oxide, polyethylene, polypropylene, polytetrafluoroethylene, polyacrylates, rubbers, e.g. ethylene-propylene-diene monomer (EPDM) rubber or styrene butadiene rubber (SBR), copolymers thereof, or mixtures thereof. The particle loading in the binder can be large, such as greater than about 80 weight percent. To form the electrode, the powders can be blended with the polymer in a suitable liquid, such as a solvent for the polymer. The resulting paste can be pressed into the electrode structure. In some embodiments, the batteries can be constructed based on the method described in U.S. Pat. No. 8,187,752 to Buckley et al, entitled “High Energy Lithium Ion Secondary Batteries”, incorporated herein by reference.

The positive electrode composition, and possibly the negative electrode composition, generally also comprises an electrically conductive powder distinct from the electroactive composition. Suitable supplemental electrically conductive powders include, for example, graphite, carbon black, metal powders, such as silver powders, metal fibers, such as stainless steel fibers, and the like, and combinations thereof. Generally, a positive electrode can comprise from about 1 weight percent to about 25 weight percent, and in further embodiments from about 2 weight percent to about 15 weight percent distinct electrically conductive powder. A person of ordinary skill in the art will recognize that additional ranges of amounts of electrically conductive powders and polymer binders within the explicit ranges above are contemplated and are within the present disclosure.

The electrode generally is associated with an electrically conductive current collector to facilitate the flow of electrons between the electrode and an exterior circuit. The current collector can comprise metal, such as a metal foil or a metal grid. In some embodiments, the current collector can be formed from nickel, aluminum, stainless steel, copper or the like. The electrode material can be cast as a thin film onto the current collector. The electrode material with the current collector can then be dried, for example in an oven, to remove solvent from the electrode. In some embodiments, the dried electrode material in contact with the current collector foil or other structure can be subjected to a pressure, such as, from about 2 to about 10 kg/cm² (kilograms per square centimeter).

The separator is located between the positive electrode and the negative electrode. The separator is electrically insulating while providing for at least selected ion conduction between the two electrodes. A variety of materials can be used as separators. Commercial separator materials are generally formed from polymers, such as polyethylene and/or polypropylene that are porous sheets that provide for ionic conduction. Commercial polymer separators include, for example, the Celgard® line of separator material from Hoechst Celanese, Charlotte, N.C. Also, ceramic-polymer composite materials have been developed for separator applications. These composite separators can be stable at higher temperatures, and the composite materials can significantly reduce the fire risk. The polymer-ceramic composites for separator materials are described further in U.S. Patent Application 2005/0031942A to Hennige et al., entitled “Electric Separator, Method for Producing the Same and the Use Thereof,” incorporated herein by reference. Polymer-ceramic composites for lithium ion battery separators are sold under the trademark Separion® by Evonik Industries, Germany.

We refer to solutions comprising solvated ions as electrolytes, and ionic compositions that dissolve to form solvated ions in appropriate liquids are referred to as electrolyte salts. Electrolytes for lithium ion batteries can comprise one or more selected lithium salts. Appropriate lithium salts generally have inert anions. Suitable lithium salts include, for example, lithium hexafluorophosphate, lithium hexafluoroarsenate, lithium bis(trifluoromethyl sulfonyl imide), lithium trifluoromethane sulfonate, lithium tris(trifluoromethyl sulfonyl) methide, lithium tetrafluoroborate, lithium perchlorate, lithium tetrachloroaluminate, lithium chloride, lithium difluoro oxalato borate, and combinations thereof. Traditionally, the electrolyte comprises a 1 M concentration of the lithium salts, although greater or lesser concentrations can be used.

For lithium ion batteries of interest, a non-aqueous liquid is generally used to dissolve the lithium salt(s). The solvent generally does not dissolve the electroactive materials. Appropriate solvents include, for example, propylene carbonate, dimethyl carbonate, diethyl carbonate, 2-methyl tetrahydrofuran, dioxolane, tetrahydrofuran, methyl ethyl carbonate, γ-butyrolactone, dimethyl sulfoxide, acetonitrile, formamide, dimethyl formamide, triglyme (tri(ethylene glycol) dimethyl ether), diglyme (diethylene glycol dimethyl ether), DME (glyme or 1,2-dimethyloxyethane or ethylene glycol dimethyl ether), nitromethane and mixtures thereof. Particularly useful electrolytes for high voltage lithium-ion batteries are described further in published U.S. Patent Application 2011/0136019 filed on Dec. 4, 2009 to Amiruddin et al., entitled “Lithium Ion Battery With High Voltage Electrolytes and Additives,” incorporated herein by reference.

The electrodes described herein can be incorporated into various commercial battery designs. For example, the cathode compositions can be used for prismatic shaped batteries, wound cylindrical batteries, coin batteries or other reasonable battery shapes. The batteries can comprise a single cathode structure or a plurality of cathode structures assembled in parallel and/or series electrical connection(s). While the positive electrode active materials can be used in batteries for primary, or single charge use, the resulting batteries generally have desirable cycling properties for secondary battery use over multiple cycling of the batteries.

In some embodiments, the positive electrode and negative electrode can be stacked with the separator between them, and the resulting stacked structure can be placed into a cylindrical or prismatic configuration to form the battery structure. Appropriate electrically conductive tabs can be welded or the like to the current collectors, and the resulting jellyroll or stack structure can be placed into a metal canister or polymer package, with the negative tab and positive tab welded to appropriate external contacts. Electrolyte is added to the canister, and the canister is sealed to complete the battery. Some presently used rechargeable commercial batteries include, for example, the cylindrical 18650 batteries (18 mm in diameter and 65 mm long) and 26700 batteries (26 mm in diameter and 70 mm long), although other battery sizes can be used.

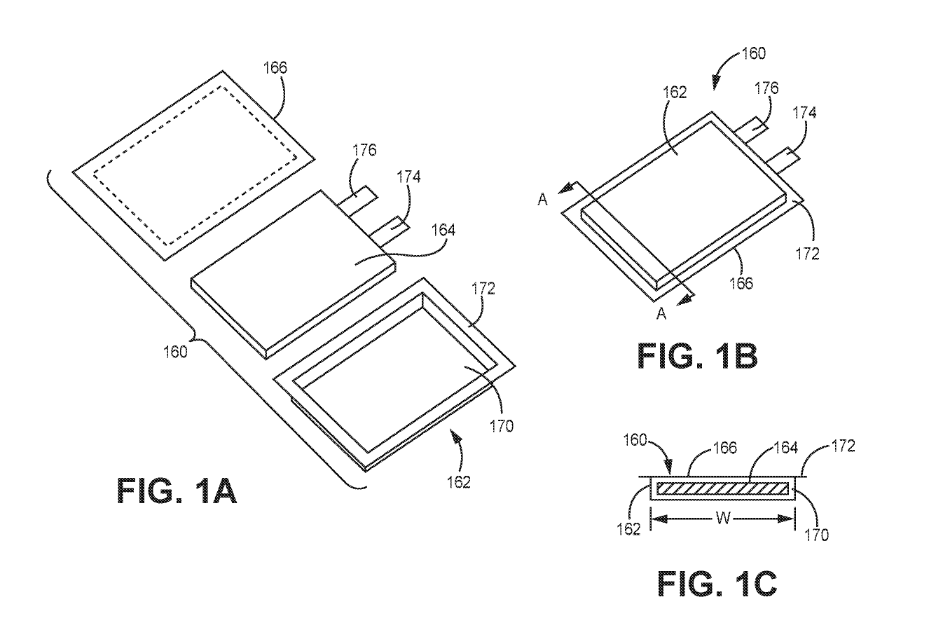

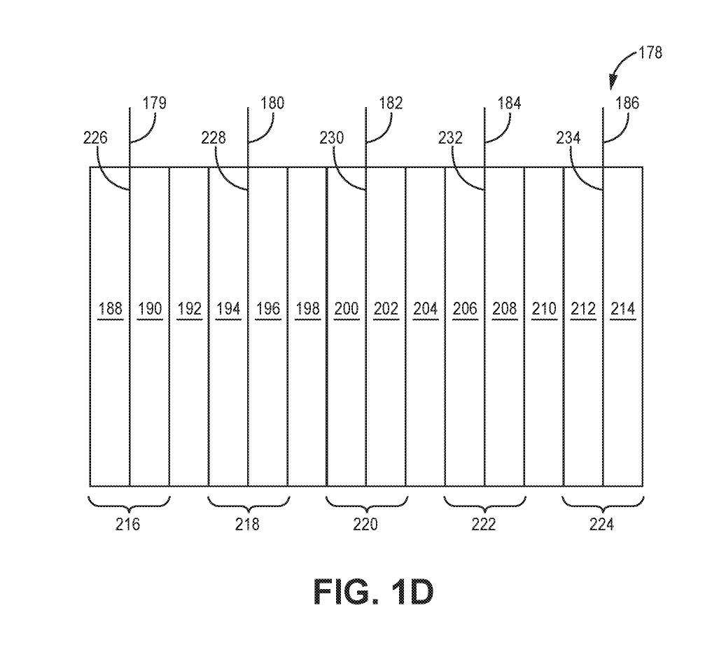

A representative embodiment of a pouch battery is shown in FIGS. 1A to 1D. In this embodiment, pouch battery 160 comprises pouch enclosure 162, battery core 164 and pouch cover 166. A battery core is discussed further below. Pouch enclosure 162 comprises a cavity 170 and edge 172 surrounding the cavity. Cavity 170 has dimensions such that battery core 164 can fit within cavity 170. Pouch cover 166 can be sealed around edge 172 to seal battery core 164 within the sealed battery, as shown in FIGS. 1B and 1C. Terminal tabs 174, 176 extend outward from the sealed pouch for electrical contact with battery core 164. FIG. 1C is a schematic diagram of a cross section of the battery of FIG. 1B viewed along the A-A line. Many additional embodiments of pouch batteries are possible with different configurations of the edges and seals.

FIG. 1D shows an embodiment of a battery core 164 that generally comprise an electrode stack. In this embodiment, electrode stack 178 comprises negative electrode structures 216, 220, 224, positive electrode structures 218, 222, and separators 192, 198, 204, 210 disposed between the adjacent positive and negative electrodes. Negative electrode structures 216, 220, 224 comprise negative electrodes 188, 190, negative electrodes 200, 202 and negative electrodes 212, 214, respectively, disposed on either side of current collectors 226, 230, 234. Positive electrode structures 218, 222 comprise positive electrodes 194, 196 and positive electrodes 206, 208, respectively, disposed on opposite sides of current collectors 228, 232, respectively. Tabs 179, 180, 182, 184, 186 are connected to current collectors 226, 228, 230, 232, 234, respectively, to facilitate the connection of the individual electrodes in series or in parallel. For vehicle applications, tabs are generally connected in parallel, so that tabs 179, 182, 186 would be electrically connected to an electrical contact accessible outside the container, and tabs 180, 184 would be electrically connected to an electrical contact as an opposite pole accessible outside the container.

### Properties and Electrochemistry

The lithium rich metal oxide materials can be cycled with a high capacity. Through an understanding of the electrochemical behavior of the materials, it has been discovered how to effectively use the material for cycling out to thousands of charge/discharge cycles while achieving high energy performance at moderate power output. The very long cycling performance is described further in the '590 application cited above. A stabilization coating can contribute significantly to this very long cycling. However, the penetrating coatings described herein can provide further desirable properties especially with respect to improved shelf life, further stabilization of cycling, and a decrease in dissolution of manganese into the electrolyte while not increasing the DC resistance beyond desired levels. Thus, the uniform and penetrating coatings can provide additional desirable performance features beyond the outstanding performance already achieved.

It has been found that positive electrode instability can result in the decomposition of the metal oxide in the cathode, and in particular manganese ions can elute from the metal oxide if unstable phases are formed at activation and/or with cycling. The transition metal that elute from the metal oxide into the electrolyte can diffuse then to the negative electrode where the metal ions can be deposited. The direct correlation of manganese migration to the negative electrode with depletion of metal from the positive electrode active material and development of pores in the positive electrode active material as a result of cycling has been described in published U.S. Patent Application 2012/0107680 to Amiruddin et al., entitled “Lithium Ion Batteries With Supplemental Lithium,” incorporated herein by reference. Another direct measure of the stability of the material with storage can be to measure the capacity fade with storage. As described below, this can be evaluated following one week storage at 60° C., which represents some degree of accelerated testing due to the high temperature.

As used herein, manganese dissolution is examined after the first formation cycle. A one step activation process can be used to perform the first charge step. In this process, the battery is charged to 4.35V or 4.6V at constant current, e.g., C/10, and then the battery is discharged to 2.0V. After a second charge to 4.35V or 4.5V, the batteries are stored for a week at 60° C. at 100% state of charge. The batteries are then fully discharged and disassembled to remove the anode. The anodes are then analyzed for metal content using inductively coupled plasma-atomic emission spectroscopy (ICP-AES) analysis. In embodiments based on a layered-layered lithium rich manganese nickel cobalt oxide with an optional dopant, the manganese dissolution as determined by a measurement of metal in the anode can be no more than about 140 parts per million by weight (ppm), in further embodiments no more than about 130 ppm and in other embodiments from about 75 ppm to about 120 ppm by weight. In addition, the total amount of Mn, Co and Ni metal in the anode after 600 cycles from 4.35V to 2V can be no more than about 200 ppm by weight, in further embodiments no more than about 175 ppm, and in other embodiments from about 100 ppm to about 150 ppm by weight. Capacity retention after storage of a charged battery at 4.5V for one week at 60° C. can be at least about 96%, in further embodiments at least about 97.5% and in additional embodiments at least about 98.5%. A person of ordinary skill in the art will recognize that additional ranges of amounts of metal dissolution into the anode and capacity retention within the explicit ranges above are contemplated and are within the present disclosure.

For commercial distribution, it can be desirable for a battery to have an appropriate shelf life to provide for storage of the battery. The shelf life can be evaluated with storage at 45° C. in a charged state at 4.35V. The battery can be cycled once from 4.35V to 2V, periodically, such as every week or two, to evaluate the capacity, and then charged and stored. With positive electrodes having materials with the uniform and penetrating coatings, the battery can maintain at least about 85% of the initial capacity, in further embodiments at least about 90%, and in other embodiments at least about 94% of the initial capacity after 12 weeks of storage at 4.35V at 45° C. A person of ordinary skill in the art will recognize that additional ranges within these explicit ranges of capacity maintenance are contemplated and are within the present disclosure.

It is desirable for the battery to produce higher quantities of useful power. The internal impedance or electrical resistance in the battery corresponds with an energy used to drive current through the battery. Due to this internal electrical resistance, the voltage across the battery electrodes is less under a load than the open circuit voltage. In principle, the internal impedance can be represented by the (V_{OC}−-V_{load})/I, where V_{OC} is the open circuit voltage, V_{load} is the voltage under a load and I is the current. A specific procedure for the measurement of the DC-resistance of a battery is given below. If the battery has a lower internal resistance, the battery can provide a greater amount of power available for external work, i.e. energy output from the battery(ies) for vehicle propulsion and accessory operation. In addition to the availability of a greater amount of available energy, a lower internal resistance also provides for a decrease in heat generation by the battery during use, which provides for a decrease in cooling to maintain the temperature of the battery and surroundings during operation.

The electrical resistance is evaluated herein using a 10 second pulse at a rate of 1 C. The electrical resistance is then calculated based on measurements at the beginning and end of the pulse using the following formula:

$$Discharge Resistance = \frac{( Voltage 1 - Voltage 2 )}{( Current 1 - Current 2 )}$$

With respect to the coating, the coating can be designed to avoid large increases in the DC resistance due to the coating. In particular, in some embodiments, the DC resistance over a range of state of charge (SOC) from 90% to 10% does not increase by more than 50%, in further embodiments by more than 40% and in other embodiments by no more than 35% relative to the DC resistance of an equivalent battery without the positive electrode coating. A person of ordinary skill in the art will recognize that additional ranges of electrical resistance changes over SOC within the explicit ranges above are contemplated and are within the present disclosure.

In addition to desirable performance of the batteries initially, the batteries formed with a uniform and penetrating coating described herein can maintain cycling capacity with reduced fade over an even greater number of cycles. For evaluation of the battery with respect to performance and as noted in the claims, battery cycling can be considered over a voltage range of 4.35V to 2.2V at a charge rate and discharge rate of 1C and at 45° C. following an initial activation cycle at a charge rate and discharge rate of C/10 followed by three cycles with charge/discharge rates of C/5. In some embodiments, the battery discharge capacity at the 1000th cycle is at least about 85% of the discharge capacity at the 5^{th} cycle, in further embodiments, at least about 87.5%, and in additional embodiments at least about 89% of the discharge capacity 5th cycle at the 1000th cycle when cycled from 4.35V to 2.2V at a discharge rate of C at 45° C. A person of ordinary skill in the art will recognize that additional ranges of cycling performance within the explicit ranges above are contemplated and are within the present disclosure.

### EXAMPLES

To test positive electrodes with different coatings, pouch cell batteries were constructed and tested against graphitic carbon as the counter electrode. The general procedure for formation of pouch cell batteries is described in the following discussion. All percentages reported in the examples are weight percents.

The examples below in general use lithium metal oxides that are high capacity positive electrode material approximately described by the formula L_{1+b}Ni_{α}Mn_{β}Co_{γ}A_{δ}O₂ with 0.05≤b≤0.125, 0.225≤α≤0.35, 0.35≤β≤0.45, 0.15≤γ≤0.3, 0≤δ≤0.05, where A is a metal different from lithium, nickel, manganese and cobalt, and up to five mole percent of the oxygen can be replaced with a fluorine dopant. High capacity cathode materials with compositions having b=0.080 and Mn as 45 mole percent of the transition metal were synthesized using a procedure disclosed in published U.S. Patent Application 2010/0086853A (the '853 application) to Venkatachalam et al. entitled “Positive Electrode Material for Lithium Ion Batteries Having a High Specific Discharge Capacity and Processes for the Synthesis of these Materials”, and published U.S. Patent Application 2010/0151332A (the '332 application) to Lopez et al. entitled “Positive Electrode Materials for High Discharge Capacity Lithium Ion Batteries”, both incorporated herein by reference.

Positive electrodes were formed from the high capacity positive electrode material powders by initially mixing it thoroughly with conductive carbon to form a homogeneous powder mixture. Separately, polyvinylidene fluoride (PVDF, KF7300™ from Kureha Corp., Japan) was mixed with N-methyl-pyrrolidone (NMP, Sigma-Aldrich) and stirred overnight to form a PVDF-NMP solution. The homogeneous powder mixture was then added to the PVDF-NMP solution and mixed for about 2 hours to form homogeneous slurry. The slurry was applied onto an aluminum foil current collector to form a thin, wet film and the laminated current collector was dried in vacuum oven at 110° C. for about two hours to remove NMP. The laminated current collector was then pressed between rollers of a sheet mill to obtain a desired lamination thickness. The dried positive electrode comprised from about 88 weight percent to 94 weight percent active metal oxide, from about 2 weight percent to about 7 weight percent conductive carbon, and from about 2 weight percent to about 6 weight percent polymer binder. The loading level on one side of the electrode is from about 7 mg/cm² to about 17 mg/cm². The electrodes have a density from about 2.4 g/mL to about 3.2 g/mL. The total electrode structure thickness is from about 45 micron to about 150 micron.

The graphitic carbon based negative electrodes comprised at least about 75 weight percent graphite and at least about 1 weight percent acetylene black with the remaining portion of the negative electrode being polymer binder. The acetylene black was initially mixed with NMP solvent to form a uniform dispersion. The graphite and polymer were added to the dispersion to form a slurry. The slurry was applied as a thin-film to a copper foil current collector. A negative electrode was formed by drying the copper foil current collector with the thin wet film in vacuum oven at 110° C. for about two hours to remove NMP. The negative electrode material was pressed between rollers of a sheet mill to obtain a negative electrode with desired thickness.

An electrolyte was selected to be stable at high voltages, and appropriate electrolytes are described in published U.S. Patent Application 2011/0136019 to Amiruddin et al., entitled “Lithium Ion Battery With High Voltage Electrolytes and Additives,” incorporated herein by reference.

To form the batteries, the electrodes were placed inside an argon filled glove box for the fabrication of the pouch cell batteries. A trilayer (polypropylene/polyethylene/polypropylene) micro-porous separator (2320 from Celgard, LLC, NC, USA) soaked with electrolyte was placed between the positive electrode and the negative electrode. Some additional electrolyte was added between the electrodes. The electrodes were then sealed using a hot press machine to seal and form a pouch cell battery. The resulting pouch cell batteries were tested with a Maccor cycle tester to obtain charge-discharge curve and cycling stability over a number of cycles.

### Example 1

### Atomic Layer Deposition of Al₂O₃

This Example demonstrates the deposition and characterization of an 8 layer Al₂O₃ ALD coating on a positive electrode.

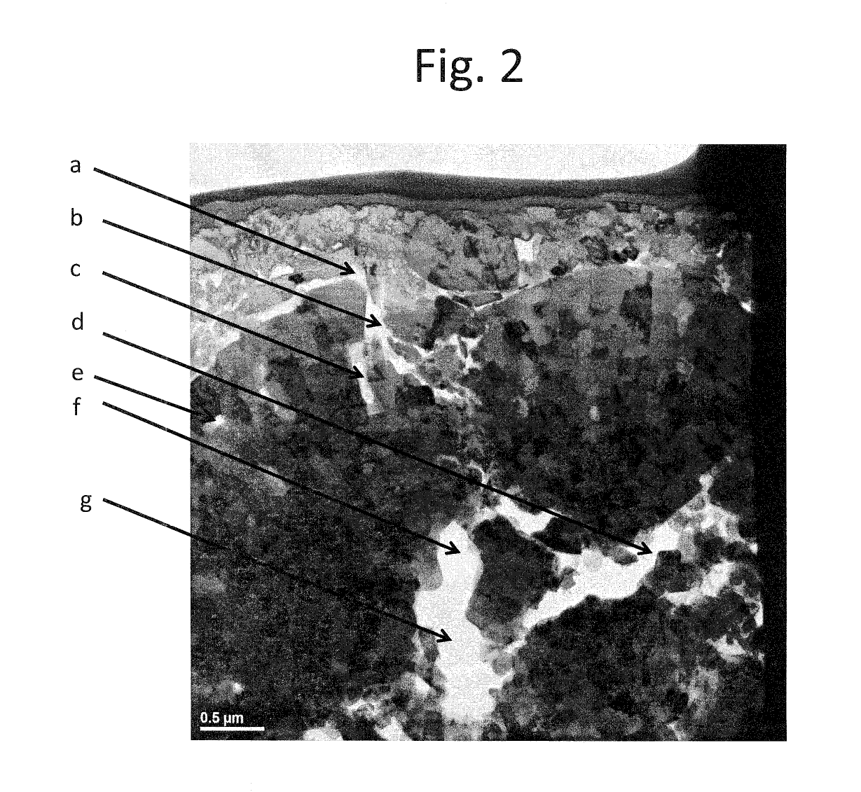

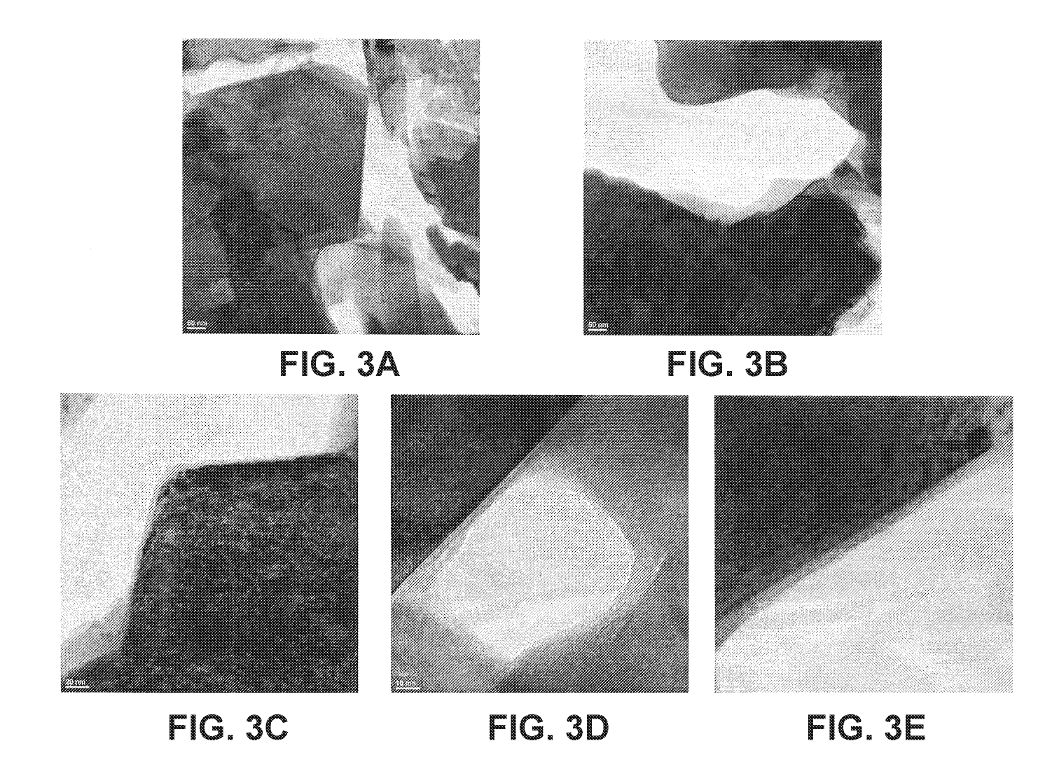

To demonstrate the ALD coating, Al₂O₃ ALD coatings were applied at the University of Colorado following the procedure described in the '082 application cited above. FIGS. 2 and 3A-3E are Focused Ion Beam—Transmission Electron Microscopy (FIB/TEM) images of a cross section of the positive electrode. FIGS. 3A-3E are FIB/TEM images showing enlargements of portions b, f, d, e and g, respectively, of the FIB/TEM image depicted in FIG. 2. Referring to FIGS. 2 and 3A-3E, the images demonstrate a relative uniform ALD coating on the particle surfaces and inside pores. The figures also suggest that the ALD coating penetrates inside deep pores and corners.

### Example 2

### Storage Stability

This Example demonstrates the effect of Al₂O₃ ALD coating layers on battery capacity retention and positive electrode stability during storage.

To demonstrate retention and stability, two sets of batteries were formed as described above. The positive electrodes of the batteries had either no coating, or 2 layers, 5 layers or 8 layers of an Al₂O₃ ALD coating for a first set of batteries and no coating or 5 layers of ALD coating for a second set of batteries. Initially, the first and second sets of batteries were charged to 4.6V and 4.35V, respectively, and were subsequently discharged to 2.0V at a C/10 charge/discharge rate. A pre-storage discharge capacity was then obtained from the second cycle by charging the batteries of set 1 and set 2 to 4.5V and 4.35V, respectively, and discharging them to 2.0V at a rate of C/10. The batteries of set 1 and set 2 where then charged to 4.5V and 4.35V at a rate of C/10, respectively, and subsequently stored for a week at 60° C. Following storage, the batteries were discharged to 2.0V at a rate of C/10 and the then charged back to 4.5V and 4.35V followed by the discharge to 2.0V at C/10 rate. The discharge capacity between 4.5V or 4.35V and 2.0V was measured from the second discharge after the storage. The capacity retention was calculated as the discharge capacity after storage relative to the pre-storage discharge capacity. Positive electrode stability was measured by performing Mn dissolution studies on the anode of the same batteries, using the procedure as described in detail above. Capacity retention results and manganese dissolution data are shown in Tables 1 and 2, respectively, for the first set of batteries and for the second set of batteries.

TABLE 1
Capacity Retention-Set 1

| | Capacity Before | Capacity After | Capacity |
|---|---|---|---|
| | Storage | Storage | Retention |
| | (mAh/g) | (mAh/g) | (%) |
| No ALD Layers | 191.29 | 181.46 | 94.86 |
| 2-Layer ALD | 190.6 | 182.4 | 95.70 |
| 5-Layer ALD | 189 | 184.6 | 97.67 |
| 8-Layer ALD | 187.4 | 186.8 | 99.68 |

Mn Dissolution-Set 1

| | Li | Ni | Co | Mn |
|---|---|---|---|---|
| No ALD Layers | 20534 | 39 | 41 | 281 |
| 2-Layer ALD | 19437 | 14 | 18 | 106 |
| 5-Layer ALD | 18581 | 14 | 18 | 99 |
| 8-Layer ALD | 17053 | 20 | 25 | 90 |

TABLE 2
Capacity Retention-Set 2

| | Capacity Before | Capacity After | Capacity |
|---|---|---|---|
| | Storage | Storage | Retention |
| | (mAh/g) | (mAh/g) | (%) |
| No ALD Layers | 166.4 | 157.7 | 94.77 |
| 5-Layer ALD | 166.09 | 157.39 | 94.76 |

Mn Dissolution-Set 2

| | Li | Ni | Co | Mn |
|---|---|---|---|---|
| No ALD Layers | 16569 | 36 | 36 | 215 |
| 5-Layer ALD | 13868 | 10 | 11 | 100 |

Table 1 demonstrates that for the batteries of set 1 (4.6V activation), increasing the number of ALD layers slightly decreased the pre-storage battery capacity but resulted in significantly improved capacity retention after storage. In contrast, the batteries of set 2 (4.35V activation) showed no clear difference in pre-storage capacity or capacity retention with respect to batteries having positive electrodes with an ALD coating and those without. Additionally, with respect to the first set of batteries demonstrated in Table 1, the dissolution results reveal that increasing the number of ALD layers led to decreased Mn dissolution from the positive electrode during storage (increase positive electrode stability) and, further, batteries having positive electrodes with 2, 5 or 8 ALD layers had less Li, Ni and Co dissolution relative to the battery having no ALD layers on the positive electrode. With respect to the batteries of set 2 demonstrated in Table 2, the battery having 5 ALD layers had significantly less Ni, Co and Mn dissolution during storage, relative to the battery without an ALD coating layer on the positive electrode, indicating the presence of the ALD layers stabilized the positive electrode during storage.

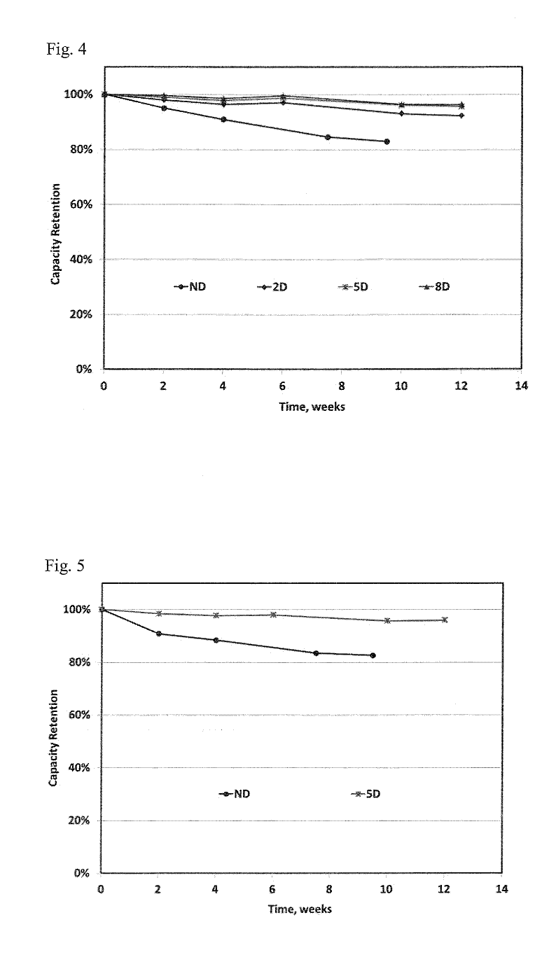

Two equivalent sets of batteries were formed and were stored for up to 12 weeks at 45° C. At selected time periods, the batteries were cycled once to evaluate the capacity of the battery in storage and then charged and returned to storage. The measured capacities of the batteries from storage are plotted as a function of storage time in FIGS. 4 and 5, respectively, for battery set 1 (initial charge to 4.6V) and set 2 (initial charge to 4.35V). FIGS. 4 and 5 demonstrate longer term capacity retention of batteries due to the ALD coatings from sets 1 and 2, respectively, during storage. Referring to the figures, batteries from sets 1 and 2 having positive electrodes with ALD coatings had significantly improved capacity retention in storage relative to the corresponding batteries having positive electrodes without an ALD coating. For the batteries from set 1 (FIG. 1A, 1B, 1C), the batteries with positive electrodes having 5 and 8 ALD coating layers had improved capacity retention relative to the battery having a positive electrode having 2 ALD coating layers, and there was essentially difference in capacity retention between batteries formed with electrodes without ALD coating and with 5 ALD layers or 8 ALD layers.

### Example 3

### DC—Resistance

The Example demonstrates the effect of Al₂O₃ ALD coating layers on the DC resistance of batteries formed with the coated positive electrodes, which are compared with DC resistance of batteries formed with cathode materials having AlF₃ coatings.

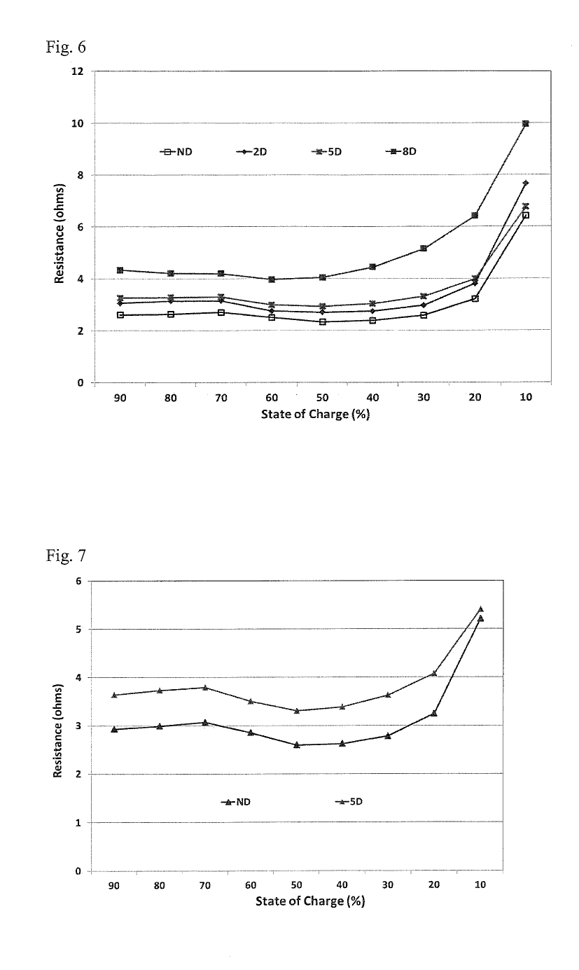

To demonstrate DC electrical resistance of batteries comprising Al₂O₃ ALD coated positive electrodes, two more sets of batteries were formed as described in Example 2 above. Batteries from set 1 (having either no coating, or 2 layers, 5 layers or 8 layers of an Al₂O₃ ALD coating) and set 2 (having either no coating or 5 layers of ALD coating) were activated by charging to 4.6V and 4.35V, respectively, subsequently discharged to 2.0V at a rate of C/10. The batteries were then cycled by charging to 4.35V at a rate of C/3 and discharging to 2.0V at a rate of C/3 with the DC resistance being measured at various points along the discharge curve, as explained in detail above. The results are plotted in FIGS. 6 and 7 for batteries from sets 1 and 2, respectively.

Referring to the figures, the presence of the ALD layers generally increased the DC resistance of the batteries, relative to the batteries having positive electrodes with no ALD layers. The results plotted in FIG. 6 (batteries of set 1) demonstrate that batteries having cathode materials with 2 ALD layers or 5 ALD layers had a modest increase in DC resistance while batteries formed with 8-ALD layers had a more significant increase in DC resistance. Batteries formed with 2 ALD layers and 5 ALD layers had comparable DC resistance values from 90% state-of-charge to 10% state-of-charge. The results in FIG. 7 (batteries of set 2) further demonstrate that the battery having 5 ALD layers had relatively modest increase in DC resistance relative to the battery not having any ALD layers. The results plotted in FIGS. 6 and 7 suggest that thicker ALD coatings, e.g, 8 ALD layers, may impede lithium insertion into the positive electrode active material, while thinner coatings, e.g., 2 or 5 ALD coatings, may increase the DC resistance modestly.

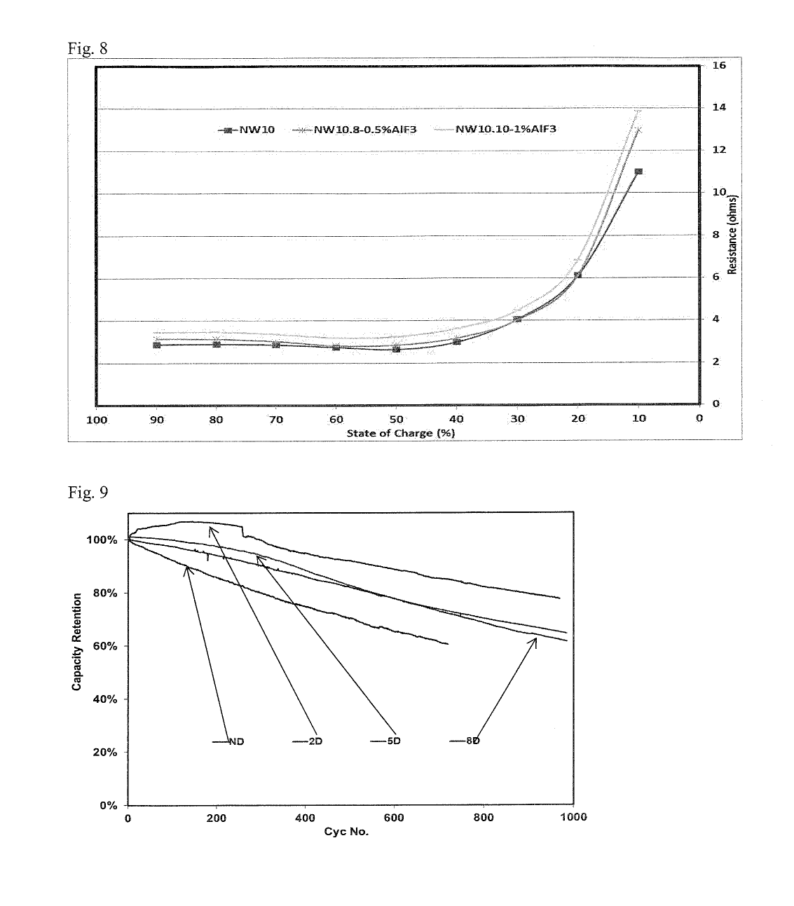

For comparison, to demonstrate DC electrical resistance of batteries comprising AlF₃ coated positive electrodes (and without Al₂O₃ ALD coatings), 3 batteries were formed. Battery 1 was formed as described above and comprised a positive electrode without an AlF₃ coating. Batteries 2 and 3 were formed as described above but comprised positive electrodes having either a 0.5 weight % or 1 weight % AlF₃ coating. The aluminum fluoride coatings were formed by depositing the coating material from a solution of aluminum nitrate and ammonium fluoride. The initially deposited coated material was then annealed by heating in an oxygen free atmosphere at a temperature from 250° C. to 600° C. The batteries were activated by charging to 4.6V and subsequently discharged to 2.0V at a rate of C/10. The batteries were then cycled by charging to 4.35V at a rate of C/3 and discharging to 2.0V at a rate of C/3 with the DC resistance being measured at various points along the discharge curve. The results are plotted in FIG. 8. Referring to the figure, the thin A1F3 nanocoating resulted in modest increases in DC resistance from 90% state-of-charge to 10% state-of-charge, which are generally consistent with the thinner ALD coatings.

### Example 4

### Cycling Stability

This Example demonstrates the effect of Al₂O₃ ALD coating layers on the cycling performance of batteries.

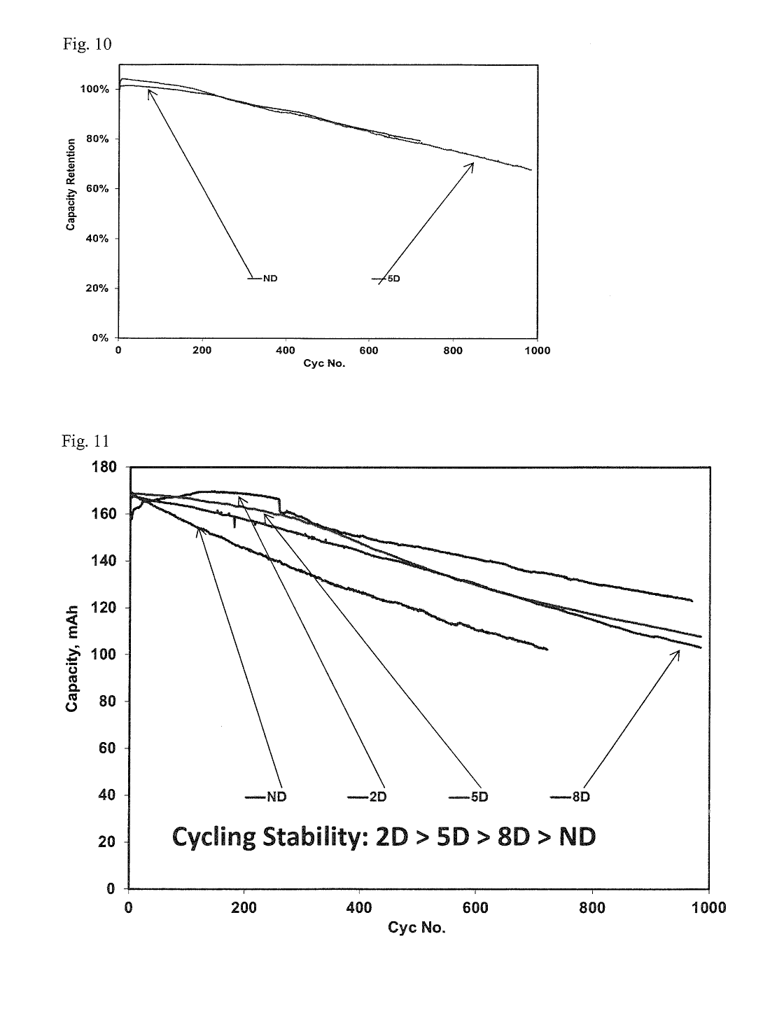

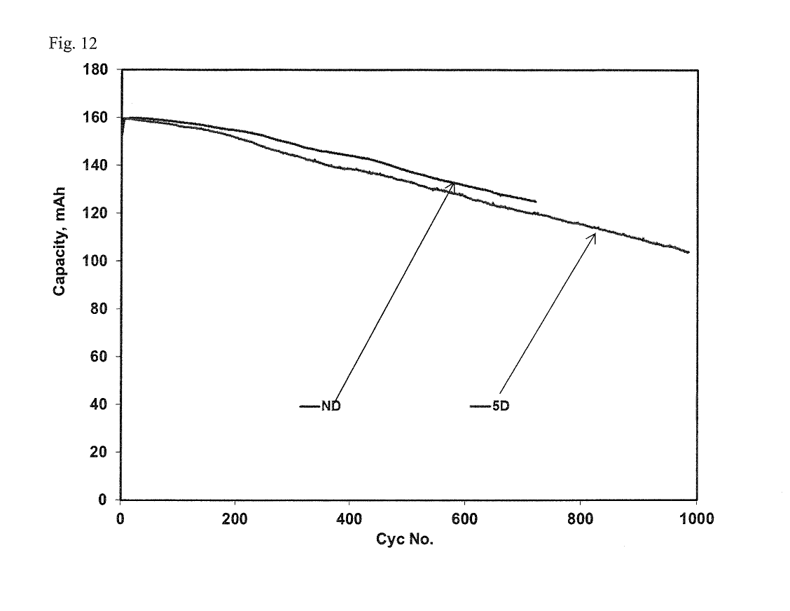

To demonstrate cycling performance, two more sets of batteries were formed as described in Example 2. Again, sets 1 (having either no coating, or 2 layers, 5 layers or 8 layers of an Al₂O₃ ALD coating) and 2 (having either no coating or 5 layers of ALD coating) were activated by charging to 4.6V and 4.35V, respectively, and subsequently discharged to 2.0V at a rate of C/10. The batteries were then cycled at 45° C. between 2.2V and 4.35V at a charge/discharge rate of 1C for at least 700 cycles. The discharge capacity of each discharge cycle was measured and the capacity retention was calculated as the discharge capacity relative to the discharge capacity of the 1st cycle at a discharge rate of C. Results are plotted in FIGS. 9 and 10 for batteries from sets 1 and 2, respectively. Referring to FIG. 9, batteries having positive electrodes with an ALD coating had significantly improved cycling performance relative to the corresponding battery having a positive electrode without an ALD coating over the cycling range. Furthermore, while the batteries comprising a 5 layer ALD coating or an 8 layer ALD coating had moderately improved capacity retention over the battery without an ALD coating, the battery comprising an electrode with a 2 layer ALD coating had significantly improved capacity retention over the cycling range relative to all other batteries of set 1 as well as the batteries of set 2. Referring to FIG. 10, there was no clear difference observed between the batteries of set 2 with activation to 4.35V, with and without an ALD coating, but only a coating thickness of 5 ALD layers was evaluated. The un-normalized specific capacity results plotted as a function of cycle number corresponding to FIGS. 9 and 10 are respectively plotted in FIGS. 11 and 12.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

What is claimed is:

1. An electrode for a lithium ion battery comprising a cathode active composition that comprises a polymer binder, electrically conductive carbon additive, and a lithium rich metal oxide with a uniform and penetrating coating with an average thickness of no more than about 5 nm, the lithium rich metal oxide approximately represented by a formula L_{1+b}Ni_{α}Mn_{β}Co_{γ}A_{δ}O₂, where b ranges from about 0.05 to about 0.3, α a ranges from 0 to about 0.4, β range from about 0.2 to about 0.65, γ ranges from 0 to about 0.46, and δ ranges from 0 to about 0.15 with the proviso that both α and γ are not zero, and where A is Mg, Sr, Ba, Cd, Zn, Al, Ga, B, Zr, Ti, Ca, Ce, Y, Nb, Cr, Fe, V, or combinations thereof, wherein the electrode has a loading level on one side of a current collector is from about 7 mg/cm² to about 17 mg/cm², and wherein the electrode can be assembled into a battery with a negative electrode capable of uptake and release of lithium and a nonaqueous electrolyte, and wherein the battery maintains at least about 85% capacity following 12 weeks of storage at 45° C. at 4.35V.

2. The electrode of claim 1 wherein 0.225≤α≤0.35, 0.3≤β≤0.55, 0.15≤γ≤0.3, 0≤δ≤0.05.

3. The electrode of claim 1 wherein b ranges from 0.024 to 0.149.

4. The electrode of claim 1 comprising from about 88 weight percent to 94 weight percent active metal oxide, from about 2 weight percent to about 7 weight percent conductive carbon, and from about 2 weight percent to about 6 weight percent polymer binder.

5. The electrode of claim 1 having a density from about 2.4 g/mL to about 3.2 g/mL.

6. The electrode of claim 1 wherein the electrode is formed on the surface of a metal foil current collector to form an electrode structure with the current collector and an electrode on one surface of the current collector having a thickness is from about 45 micron to about 150 micron.

7. The electrode of claim 1 wherein the uniform and penetrating coating comprises Al₂O₃.

8. The electrode of claim 1 wherein the coating comprises from 1 to 6 atomic deposited layers.

9. The electrode of claim 1 wherein the electrode assembled into a battery maintains at least about 90% capacity following 12 weeks of storage at 45° C. at 4.35V.

10. The electrode of claim 1 having a capacity when assembled into a cell at the 1000th cycle that is at least about 75% of the 5th cycle capacity cycling at 1 C discharge rate at 45° C. between 4.35V and 2.2V.

11. The electrode of claim 1 wherein the electrode is pressed with a pressure from about 2 to about 10 kg/cm² (kilograms per square centimeter).

12. The electrode of claim 1 having manganese deposition in a carbon based counter electrode of from about 75 ppm to about 120 ppm as measured following discharge to 2V after a week of storage at 4.35V at 60° C.

13. The electrode of claim 1 having a total deposition of manganese, nickel and cobalt in a carbon based electrode of no more than about 200 ppm as measured following discharge to 2V after a week of storage at 4.35V at 60° C.

14. A lithium ion cell comprising the electrode of claim 1 and a negative electrode comprising graphitic carbon.

15. A lithium ion cell comprising the electrode of claim 1 and a negative electrode comprising a silicon-based active material.

16. A lithium ion cell comprising the electrode of claim 1 and a negative electrode comprising a silicon oxide based active material.
